(19) United States
(12) Patent Application Publication
(10) Pub. No.: US 2026/0171919 A1
(43) Pub. Date: Jun. 18, 2026

(54) POWER CONVERSION CIRCUIT CAPABLE OF ADJUSTING THE RESONANCE PERIOD TO IMPROVE THE EFFICIENCY OF LOW OUTPUT POWER AND CONTROL METHOD THEREOF

(71) Applicant: Richtek Technology Corporation, Zhubei City (TW)

(72) Inventors: Tzu-Chen LIN, Zhubei City (TW); Ta-Yung YANG, Taoyuan City (TW)

(21) Appl. No.: 19/311,289

(22) Filed: Aug. 27, 2025

Related U.S. Application Data
(60) Provisional application No. 63/730,980, filed on Dec. 12, 2024.

(30) Foreign Application Priority Data
Jul. 24, 2025 (TW) 114128042

(51) Int. Cl. H02M 3/335; H02M 1/00; H02M 1/38; H02M 3/338

(52) U.S. Cl. CPC H02M 3/33576; H02M 1/0009; H02M 1/0048; H02M 1/38; H02M 3/33571; H02M 3/3382

(57) ABSTRACT

A power conversion circuit includes a transformer, a resonant capacitor, a high-side transistor, a low-side transistor, an auxiliary capacitor, an auxiliary switch, and a control circuit. The transformer includes a primary coil and a secondary coil. The primary coil is coupled between a switch node and a resonant node. The resonant capacitor is coupled between the resonant node and a ground. The high-side transistor provides an input voltage to the switch node, and the low-side transistor couples the switch node to the ground. The auxiliary capacitor is coupled to the resonant node. The auxiliary switch is coupled between the auxiliary capacitor and the ground. The control circuit drives the high-side transistor and the low-side transistor, and turns on the auxiliary switch based on a current flowing through the resonant capacitor, so that the auxiliary capacitor is coupled in parallel with the resonant capacitor.

### CROSS REFERENCE TO RELATED APPLICATIONS

This application claims the benefit of U.S. Provisional Application No. 63/730,980, filed on Dec. 12, 2024, the entirety of which is incorporated by reference herein.

This application claims priority of Taiwan Patent Application No. 114128042, filed on Jul. 24, 2025, the entirety of which is incorporated by reference herein.

### BACKGROUND OF THE INVENTION

### Field of the Invention

The disclosure is generally related to a power conversion circuit and a control method thereof, and more particularly it is related to a power conversion circuit capable of adjusting the resonance period to improve the efficiency of low output power and a control method thereof.

### Description of the Related Art

With the continuous development of portable electronic devices, the development trend of power conversion circuits, like most power products, is towards high efficiency, high power density, high reliability, and low cost. Resonant power conversion circuits (including LLC resonant power conversion circuits) have the advantages of zero-voltage switching (ZVS) on the primary side and zero-current switching (ZCS) of the rectification diode on the secondary side within a full load range, using frequency control to keep the duty cycles of both the high-side transistor and low-side transistor close to 50%, eliminating the need for an output inductor, and allowing the use of low-voltage transistors on the secondary side to reduce costs and improve efficiency. In recent years, they have been increasingly adapted in DC voltage conversion circuits.

However, due to the circuit characteristics of resonant power conversion circuits, a higher switching frequency must be used in response to low output voltage or light load, resulting in poor conversion efficiency of resonant power conversion circuits. In order to meet the current market demand for a wide range of output voltages, high output power, and high conversion efficiency, it is necessary to further optimize power conversion circuits to meet market demand.

### BRIEF SUMMARY OF THE INVENTION

The present invention proposes a resonant power conversion circuit and a control method thereof. By connecting an additional auxiliary capacitor in parallel with the resonant capacitor, the maximum primary current of the primary coil and the maximum output current of the secondary coil are reduced, which helps to reduce the conduction loss of the low-side transistor and the rectification transistor, thereby improving the conversion efficiency at the conditions of low output voltage and light load. In addition, by adjusting the charging period of the auxiliary capacitor, the equivalent capacitance value of the auxiliary capacitor may be adjusted. When the auxiliary capacitor is connected in parallel with the resonant capacitor, the resonant period of the resonant power conversion circuit may be adjusted to a wider extent, allowing the resonant power conversion circuit to generate a wider range of output voltages and improve the conversion efficiency at low output power.

In an embodiment, a power conversion circuit is provided, which comprises a transformer, a resonant capacitor, a high-side transistor, a low-side transistor, an auxiliary capacitor, an auxiliary switch, and a control circuit. The transformer comprises a primary coil and a secondary coil, where the primary coil is coupled between a switch node and a resonant node. The resonant capacitor is coupled between the resonant node and a ground. The high-side transistor provides an input voltage to the switch node based on a high-side driving signal. The low-side transistor couples the switch node to the ground based on a low-side driving signal. The auxiliary capacitor is coupled between the resonant node and an auxiliary node. The auxiliary switch is coupled between the auxiliary node and the ground. The control circuit generates the high-side driving signal and the low-side driving signal. The control circuit turns on the auxiliary switch based on a primary current flowing through the resonant capacitor, so that the auxiliary capacitor is connected in parallel with the resonant capacitor.

According to an embodiment of the present invention, the power conversion circuit further comprises a current detection circuit. The current detection circuit is configured to detect the primary current to generate a current detection signal. When the primary current flows from the resonant node to the ground, the current detection signal is positive. When the primary current flows from the ground to the resonant node, the current detection signal is negative.

According to an embodiment of the present invention, the current detection circuit comprises a first capacitor and a first resistor. The first capacitor is coupled to the resonant node. The first resistor is coupled between the first capacitor and the ground. A voltage across the first resistor generates the current detection signal.

According to an embodiment of the present invention, when the current detection signal is positive, the control circuit turns off the auxiliary switch.

According to another embodiment of the present invention, when the current detection signal is positive and the high-side transistor is turned off, the control circuit turns off the auxiliary switch.

According to an embodiment of the present invention, when the current detection signal transitions to negative and a delay time has elapsed, the control circuit turns on the auxiliary switch.

According to an embodiment of the present invention, the control circuit further comprises a delay circuit. The delay circuit is configured to generate a first signal and a second signal. The delay circuit enables the first signal during a period from the high-side transistor being turned off to the current detection signal dropping to zero. When the current detection signal drops to zero, the delay circuit enables the second signal. An enable period of the second signal is substantially equal to an enable period of the first signal. The delay time is equal to the enable period of the second signal.

According to an embodiment of the present invention, a resonant frequency of the power conversion circuit is determined by the resonant capacitor and a leakage inductance of the primary coil. The delay time does not exceed one-quarter of the resonant frequency.

According to an embodiment of the present invention, when the control circuit turns on the auxiliary switch, a voltage across the auxiliary capacitor is close to a voltage across the resonant capacitor.

In another embodiment, a power conversion circuit is provided, which comprises a transformer, a resonant capacitor, a high-side transistor, a low-side transistor, an auxiliary capacitor, an auxiliary switch, and a control circuit. The transformer comprises a primary coil and a secondary coil, where the primary coil is coupled between a switch node and a resonant node. The resonant capacitor is coupled between the resonant node and a ground, where a primary current flows through the resonant capacitor. The high-side transistor provides an input voltage to the switch node based on a high-side driving signal. The low-side transistor couples the switch node to the ground based on a low-side driving signal. The auxiliary capacitor is coupled between the resonant node and an auxiliary node. The auxiliary switch is coupled between the auxiliary node and the ground. The control circuit generates the high-side driving signal and the low-side driving signal. When a parasitic diode of the auxiliary switch is turned on, the auxiliary switch is turned on so that the auxiliary capacitor is connected in parallel with the resonant capacitor.

According to an embodiment of the present invention, when the primary current flows from the resonant node to the ground, the control circuit turns off the auxiliary switch.

According to an embodiment of the present invention, when the primary current flows from the resonant node to the ground and the high-side transistor is turned off, the control circuit turns off the auxiliary switch.

According to an embodiment of the present invention, the power conversion circuit further comprises a current detection circuit. The current detection circuit is configured to detect the primary current to generate a current detection signal. When the primary current flows from the resonant node to the ground, the current detection signal is positive. When the primary current flows from the ground to the resonant node, the current detection signal is negative. When the current detection signal is positive, the control circuit turns off the auxiliary switch. When the current detection signal is negative, the control circuit turns on the auxiliary switch.

According to an embodiment of the present invention, when the auxiliary switch is turned on, the auxiliary switch achieves zero-voltage switching.

According to an embodiment of the present invention, the power conversion circuit further comprises a detection diode. The detection diode comprises an anode and a cathode. The anode is coupled to a detection node, the cathode is coupled to the auxiliary node. The control circuit further comprises a current source, and the current source provides a fixed current to flow through the detection diode. When a voltage of the detection node is less than a threshold, the control circuit determines that a parasitic diode of the auxiliary switch is turned on and turns on the auxiliary switch.

In yet another embodiment, a control method for controlling a power conversion circuit is provided. The power conversion circuit comprises a resonant capacitor coupled between a resonant node and a ground, a transformer comprising a primary coil and a secondary coil, a high-side transistor providing an input voltage to a switch node, and a low-side transistor coupling the switch node to the ground. The primary coil is coupled between the switch node and the resonant node. The control method comprises the following steps. The high-side transistor is turned on to magnetize the transformer and to charge the resonant capacitor. The high-side transistor is turned off and the low-side transistor is turned on so that the secondary coil generates an output voltage. An auxiliary capacitor is connected in parallel with the resonant capacitor based on a primary current flowing through the resonant capacitor.

According to an embodiment of the present invention, the step of connecting the auxiliary capacitor in parallel with the resonant capacitor based on the primary current flowing through the resonant capacitor further comprises the following steps. When the primary current flows from the resonant node to the ground and the high-side transistor is turned off, the auxiliary capacitor is electrically separated from the resonant capacitor.

According to another embodiment of the present invention, the step of connecting the auxiliary capacitor in parallel with the resonant capacitor based on the primary current flowing through the resonant capacitor further comprises the following steps. The auxiliary capacitor is electrically separated from the resonant capacitor when the primary current flows from the resonant node to the ground. The auxiliary capacitor is connected in parallel with the resonant capacitor when the primary current flows from the ground to the resonant node.

According to yet another embodiment of the present invention, the step of connecting the auxiliary capacitor in parallel with the resonant capacitor when the primary current flows from the ground to the resonant node further comprises the following steps. The auxiliary capacitor is connected in parallel with the resonant capacitor when a voltage across the auxiliary capacitor is close to a voltage across the resonant capacitor.

According to an embodiment of the present invention, the auxiliary capacitor is coupled to an auxiliary switch. The auxiliary capacitor is connected in parallel with the resonant capacitor when the auxiliary switch is turned on. The auxiliary switch achieves zero-voltage switching when the auxiliary switch is turned on.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a circuit diagram of a power conversion circuit in accordance with an embodiment of the present invention;

FIG. 2 is a waveform diagram of a power conversion circuit in accordance with an embodiment of the present invention;

FIG. 3 is a circuit diagram of a power conversion circuit in accordance with another embodiment of the present invention;

FIG. 4 is a circuit diagram of a delay circuit in accordance with an embodiment of the present invention;

FIG. 5 is a circuit diagram of a pulse generation circuit in accordance with an embodiment of the present invention;

FIG. 6 is a waveform diagram of a power conversion circuit in accordance with an embodiment of the present invention;

FIG. 7 is a circuit diagram of a power conversion circuit in accordance with yet another embodiment of the present invention;

FIG. 8 is a circuit diagram of a detection circuit in accordance with an embodiment of the present invention; and

FIG. 9 is a flow chart of a control method for a power conversion circuit in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

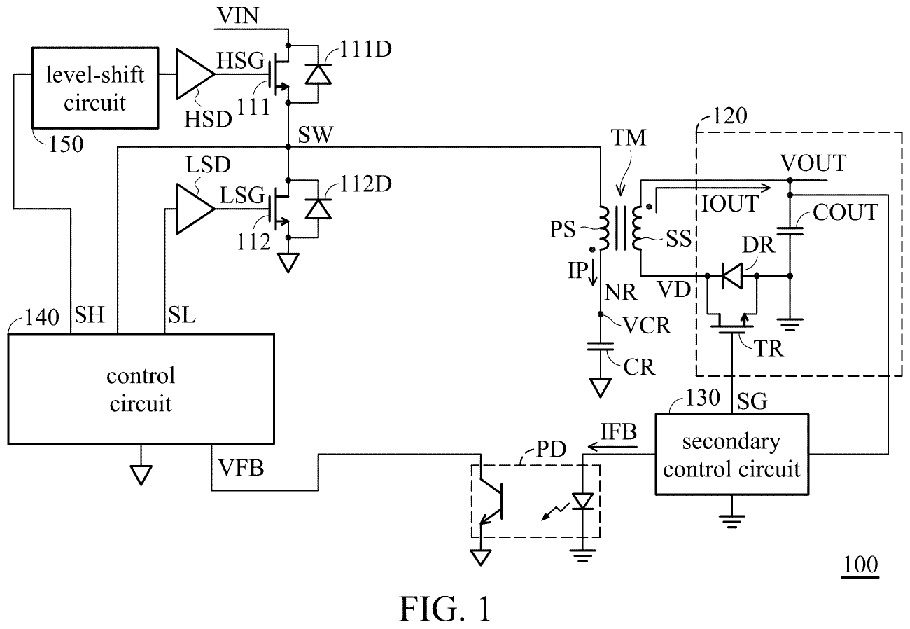

FIG. 1 is a circuit diagram of a power conversion circuit in accordance with an embodiment of the present invention. As shown in FIG. 1, the power conversion circuit 100 includes a high-side transistor 111, a low-side transistor 112, a resonant capacitor CR, a transformer TM, a rectification circuit 120, a secondary control circuit 130, an opto-coupler PD, a control circuit 140, a level-shift circuit 150, a high-side driving circuit HSD, and a low-side driving circuit LSD.

The high-side transistor 111 provides an input voltage VIN to a switch node SW based on a high-side gate driving signal HSG. According to an embodiment of the present invention, the high-side transistor 111 includes a high-side parasitic diode 111D, where the high-side parasitic diode 111D is coupled between the switch node SW and the input voltage VIN. The low-side transistor 112 couples the switch node SW to the ground based on the low-side gate driving signal LSG. According to an embodiment of the present invention, the low-side transistor 112 includes a low-side parasitic diode 112D, where the low-side parasitic diode 112D is coupled between the switch node SW and the ground.

The resonant capacitor CR is coupled between the resonant node NR and the ground, and a resonant voltage VCR is generated across the resonant capacitor CR. The transformer TM includes a primary coil PS and a secondary coil SS. The primary coil PS is coupled between the switch node SW and the resonant node NR. The output current IOUT generated by the secondary coil SS generates an output voltage VOUT through the rectification circuit 120.

According to some embodiments of the present invention, the primary coil PS and the resonant capacitor CR are connected in series between the switch node SW and the ground. In other words, the resonant capacitor CR may be coupled between the switch node SW and the resonant node NR, and the primary coil PS may be coupled between the resonant node NR and the ground.

The rectification circuit 120 is configured to convert the output current IOUT generated by the secondary coil SS into an output voltage VOUT, and includes a rectification transistor TR and an output capacitor COUT. According to some embodiments of the present invention, the rectification transistor TR further includes a rectification parasitic diode DR. The rectification transistor TR is turned on based on the gate signal SG, so that the output current IOUT output by the secondary coil SS charges the output capacitor COUT to generate the output voltage VOUT. When the rectification transistor TR is turned off, the voltage from the drain terminal to the source terminal of the rectification transistor TR is the drain voltage VD.

The secondary control circuit 130 generates a feedback current IFB based on the output voltage VOUT, where the feedback current IFB generates a feedback voltage VFB through the opto-coupler PD. The secondary control circuit 130 further generates the gate signal SG for converting the output current IOUT generated by the secondary coil SS into the output voltage VOUT.

The control circuit 140 is powered by the supply voltage VDD and generates a high-side driving signal SH and a low-side driving signal SL based on the feedback voltage VFB. The level-shift circuit 150 is configured to shift the voltage level of the high-side driving signal SH to the input voltage VIN, and the high-side drive circuit HSD generates the high-side gate driving signal HSG based on the shifted signal to drive the high-side transistor 111. The low-side driving circuit LSD generates a low-side gate driving signal LSG based on the low-side driving signal SL to drive the low-side transistor 112.

According to some embodiments of the present invention, the control circuit 140 further generates a high-side driving signal SH and a low-side driving signal SL according to the voltage of the switch node SW, so that both the high-side transistor 111 and the low-side transistor 112 achieve zero-voltage switching (ZVS) to improve the conversion efficiency of the power conversion circuit 100. According to some embodiments of the present invention, the power conversion circuit 100 may be a resonant power conversion circuit. According to some embodiments of the present invention, the power conversion circuit 100 may be a resonant flyback power conversion circuit. According to some embodiments of the present invention, the power conversion circuit 100 may be an asymmetrical half-bridge flyback power conversion circuit.

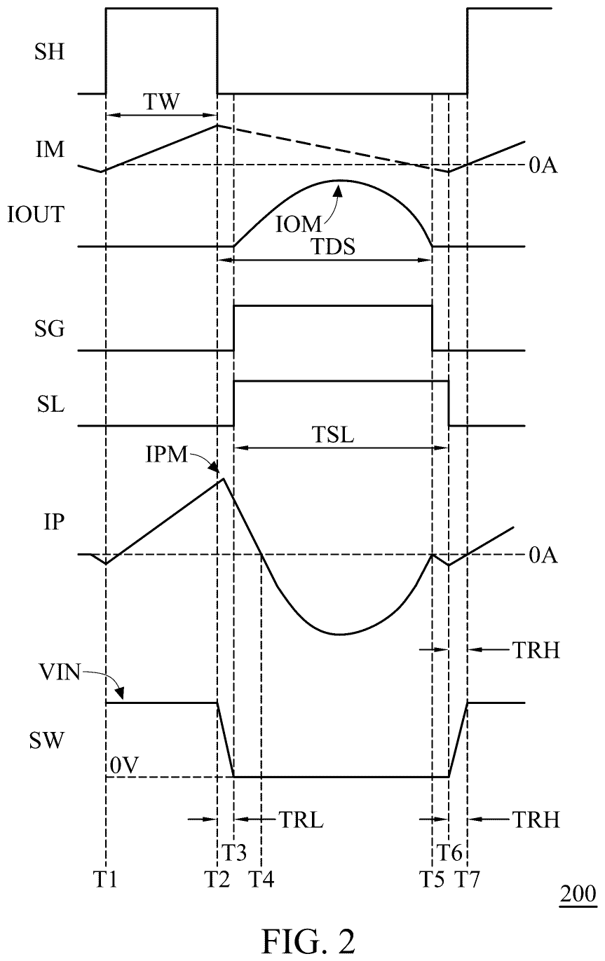

FIG. 2 is a waveform diagram of a power conversion circuit in accordance with an embodiment of the present invention. The following description of the waveform diagram 200 will be described in detail in conjunction with the power conversion circuit 100 of FIG. 1. From the first time point T1 to the second time point T2, the high-side transistor 111 is turned on based on the high-side driving signal SH (i.e., the high-side driving signal SH is at the high logic level). The high-side conduction time TW is the conduction time of the high-side transistor 111. During the high-side conduction time TW, the transformer TM is magnetized to generate a magnetizing current IM. As the conduction time TW increases, the magnetizing current IM of the transformer TM, the primary current IP flowing through the primary coil PS, and the resonant voltage VCR all increase accordingly. In other words, the high-side conduction time TW is the magnetizing time of the transformer TM.

When the high-side transistor 111 is turned off (i.e., the high-side driving signal SH is at the low logic level), the transformer 10 is demagnetizing. During the demagnetization period TDS, the transformer 10 generates an output current IOUT, and the conduction time of the low-side transistor 112 (i.e., the low-side driving signal SL is at the high logic level) corresponds to the demagnetization period TDS. According to some embodiments of the present invention, the low-side conduction time TSL of the low-side driving signal SL is equal to or greater than the demagnetization period TDS. During the demagnetization period TDS, the voltage across the primary coil PS is equal to the resonant voltage VCR, and the output voltage VOUT is as shown in Eq. 1.

$$VCR = n \times VOUT \qquad ( Eq . 1 )$$

$$n = \frac{NP}{NS}$$

NP is the number of turns of the primary coil PS, NS is the number of turns of the secondary coil SS, and the turn ratio n is the number of turns of the primary coil PS divided by the number of turns of the secondary coil SS.

The demagnetization period TDS is shown in Eq. 2.

$$TDS = \frac{( VIN - VCR ) \times TW}{n \times VOUT} \qquad ( Eq . 2 )$$

When the high-side transistor 111 is turned on, (VIN-VCR) is the voltage configured to magnetize the transformer TM.

At the second time point T2, the high-side driving signal SH is converted to the low logic level to turn off the high-side transistor 111. At the third time point T3, the low-side driving signal SL is converted to the high logic level to turn on the low-side transistor 112. According to some embodiments of the present invention, the first dead time TRL from the second time point T2 to the third time point T3 is the dead time from the high-side transistor 111 being turned off to the low-side transistor 112 being turned on. According to some embodiments of the present invention, the primary current IP reaches the maximum primary current IPM during the period from the second time point T2 to the third time point T3.

According to some embodiments of the present invention, during the first dead time TRL, the circulating current generated by the primary coil PS turns on the low-side parasitic diode 112D, and pulls down the voltage of the switch node SW, so that the low-side transistor 112 reaches zero-voltage switching. At the third time point T3, the voltage across the primary coil PS is the resonant voltage VCR of the resonant capacitor CR.

From the third time point T3 to the fourth time point T4, the high-side transistor 111 is turned off, and the low-side transistor 112 is turned on under zero-voltage switching. The rectification transistor TR is turned on, so that the output current IOUT flows through the rectification transistor TR to generate an output voltage VOUT, where the output voltage VOUT is equal to the resonant voltage VCR divided by the turn ratio n, as shown in Eq. 1. In addition, the primary current IP is still positive and flows into the resonant capacitor CR.

According to some embodiments of the present invention, the leakage inductance of the primary coil PS and the resonant capacitor CR form a resonant tank. The output current IOUT is in the form of a sine wave, and the frequency is determined by the resonant frequency of the resonant circuit. The primary current IP is the reflection of the magnetizing current IM plus the output current IOUT.

From the fourth time point T4 to the fifth time point T5, the high-side transistor 111 is continuously turned off and the low-side transistor 112 is continuously turned on. The energy of the transformer TM is continuously transferred to the secondary winding SS, and the energy at this time is provided by the resonant capacitor CR. In addition, since the low-side transistor 112 is continuously turned on, the energy of the resonant capacitor CR is configured to bring the magnetizing current IM to a negative value. According to some embodiments of the present invention, the output current IOUT reaches the maximum output current IOM during the period from the fourth time point T4 to the fifth time point T5.

At the fifth time point T5, the rectification transistor TR is not turned on based on the gate signal SG, thereby ending the demagnetization period TDS. From the fifth time point T5 to the sixth time point T6, the resonant capacitor CR continues to reversely magnetize the primary winding PS, so that the primary current IP remains negative until the low-side transistor 112 is turned off.

From the sixth time point T6 to the seventh time point T7, the high-side transistor 111 and the low-side transistor 112 are both turned off, and the primary current IP induced as a negative current from the fifth time point T5 to the sixth time point T6 turns on the high-side parasitic diode 111D, so that the voltage of the switch node SW rises to the input voltage VIN. According to some embodiments of the present invention, the second dead time TRH from the sixth time point T6 to the seventh time point T7 is the dead time from the low-side transistor 112 being turned off to the high-side transistor 111 being turned on.

At the seventh time point T7, the high-side driving signal SH is at the high logic level. Since the voltage of the switch node SW rises to the input voltage VIN, the high-side transistor 111 is able to be turned under zero-voltage switching.

Since the resonant capacitor CR is connected in parallel with the primary coil PS when the transformer TM is demagnetized, the resonant voltage VCR is the output voltage VOUT multiplied by the turn ratio of the transformer TM. When the voltage difference between the resonant voltage VCR and the output voltage VOUT multiplied by the turn ratio is too large, the drain voltage VD would generate a very high voltage spike, reducing the reliability of the rectification transistor TR and even damaging the rectification transistor TR.

However, under the situation that the output voltage VOUT is low or the output power of the output voltage VOUT is low, when the secondary control circuit 130 turns off the rectification transistor TR at the fifth time point T5 since the output voltage VOUT is too high, the output current IOUT does not drop to zero and the primary current IP does not rise to zero, resulting in a decrease in the conversion efficiency of the power conversion circuit 100. Therefore, it is necessary to optimize the power conversion circuit 100.

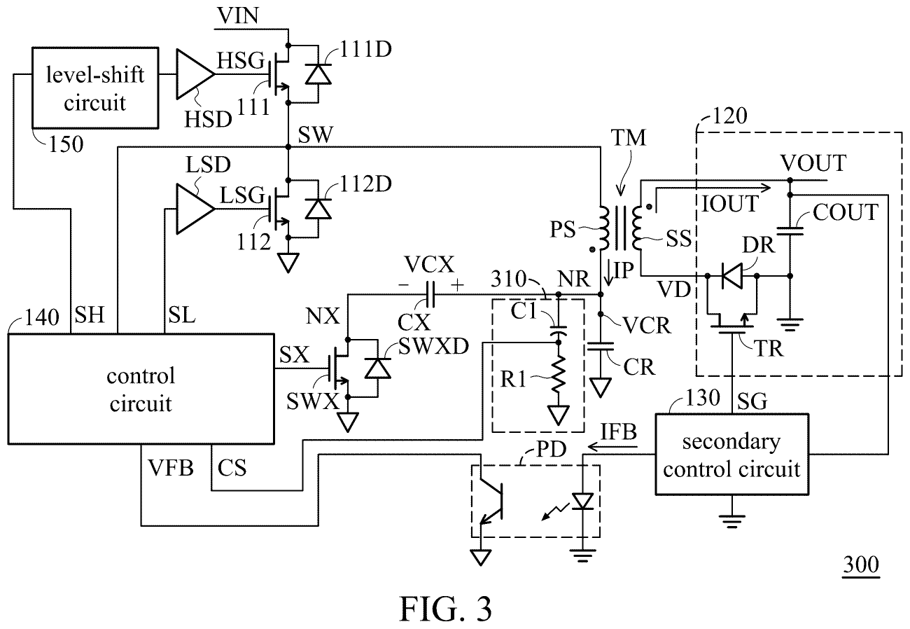

FIG. 3 is a circuit diagram of a power conversion circuit in accordance with another embodiment of the present invention. Compared the power conversion circuit 300 to the power conversion circuit 100 of FIG. 1, the power conversion circuit 300 further includes a current detection circuit 310, an auxiliary capacitor CX, and an auxiliary switch SWX.

The current detection circuit 310 is configured to detect the primary current IP and generate a current detection signal CS. As shown in FIG. 3, the current detection circuit 310 includes a first capacitor C1 and a first resistor R1, where the first capacitor C1 is coupled to the resonant node NR, and the first resistor R1 is coupled between the first capacitor C1 and the ground. According to some embodiments of the present invention, the voltage across the first resistor R1 is the current detection signal CS. According to some embodiments of the present invention, the capacitance of the first capacitor C1 is smaller than the capacitance of the auxiliary capacitor CR.

The auxiliary capacitor CX is coupled between the resonant node NR and the auxiliary node NX, and the auxiliary switch SWX is coupled between the auxiliary node NX and the ground. As shown in FIG. 3, the auxiliary switch SWX is controlled by the auxiliary signal SX and includes an auxiliary parasitic diode SWXD. According to some embodiments of the present invention, the control circuit 140 turns on the auxiliary switch SWX based on the current detection signal CS, so that the auxiliary capacitor CX is connected in parallel with the resonant capacitor CR. In other words, the control circuit 140 connects the auxiliary capacitor CX in parallel with the resonant capacitor CR based on the primary current IP.

According to some embodiments of the present invention, when the auxiliary capacitor CX is connected in parallel with the resonant capacitor CR, the resonant period of the power conversion circuit 300 can be adjusted, which helps reduce the maximum output current IOM and the maximum primary current IPM (as shown in FIG. 2) when the output voltage VOUT is low or the load is light, thereby reducing the conduction loss of the rectification transistor TR and the low-side transistor 112, thereby improving the conversion efficiency at low output voltage and light load.

According to an embodiment of the present invention, when the current detection signal CS is positive, it indicates that the primary current IP flows from the resonant node NR to the ground. According to another embodiment of the present invention, when the current detection signal CS is negative, it indicates that the primary current IP flows from the ground to the resonant node NR. According to yet another embodiment of the present invention, when the current detection signal CS is zero, it indicates that the primary current IP is zero. The control circuit 140 determines the direction and magnitude of the primary current IP based on the current detection signal CS.

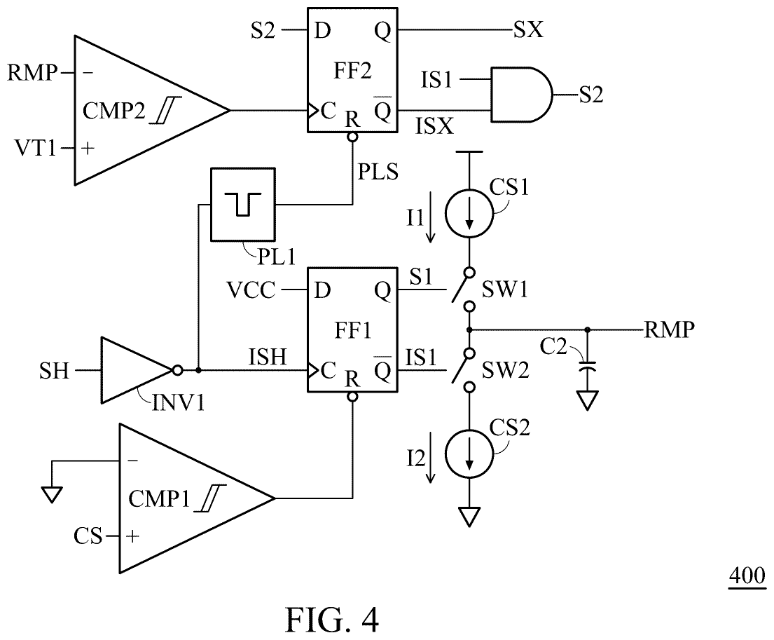

FIG. 4 is a circuit diagram of a delay circuit in accordance with an embodiment of the present invention. According to some embodiments of the present invention, the control circuit 140 of FIG. 3 includes the delay circuit 400 of FIG. 4. As shown in FIG. 4, the delay circuit 400 includes a first inverter INV1, a first flip-flop FF1, a first switch SW1, a first current source CS1, a second switch SW2, a second capacitor C2, a second current source CS2, and a first comparator CMP1.

The first inverter INV1 is configured to invert the high-side driving signal SH to generate an inverted high-side driving signal ISH. The first flip-flop FF1 uses the inverted high-side driving signal ISH as a clock signal to generate a first signal S1 and a first inverted signal IS1. According to an embodiment of the present invention, when the high-side driving signal SH is disabled to turn off the high-side transistor 111, the first flip-flop FF1 outputs the supply voltage VCC as the first signal S1 based on the rising edge of the inverted high-side driving signal ISH, thereby enabling the first signal S1 and disabling the first inverted signal IS1. Based on the first signal S1 being enabled, the first switch SW1 provides the first current I1 generated by the first current source CS1 to the second capacitor C2, so that the first current I1 charges the second capacitor C2 to generate the sawtooth wave RMP.

According to another embodiment of the present invention, when the current detection signal CS drops below zero, the first comparator CMP1 resets the first flip-flop FF1, so that the first flip-flop FF1 disables the first signal S1 and enables the first inverted signal IS1. The first inverting signal IS1 being enabled turns on the second switch SW2, so that the second current I2 generated by the second current source CS2 discharges the second capacitor C2, causing the sawtooth wave RMP to drop.

As shown in FIG. 4, the delay circuit 400 further includes a first pulse generation circuit PL1, a second flip-flop FF2, a second comparator CMP2, and a first AND gate AND1. When the high-side driving signal SH is disabled, the first pulse generation circuit PL1 generates a negative pulse on the pulse signal PLS to reset the second flip-flop FF2, thereby disabling the auxiliary signal SX and enabling the inverted auxiliary signal ISX. When the current detection signal CS drops to zero to reset the first flip-flop FF1, the enabled inverted auxiliary signal ISX and the enabled inverted first signal IS1 enable the second signal S2 via the first AND gate AND1. When the sawtooth waveform RMP drops below the first threshold voltage VT1, the second flip-flop FF2 enables the auxiliary signal SX based on the rising edge of the output of the second comparator CMP2 to disable the second signal S2.

In other words, in the embodiment of FIG. 4, when the high-side transistor 111 is turned off, the auxiliary switch SWX is turned off, so that the auxiliary capacitor CX is not connected in parallel with the resonant capacitor CR, and the primary current IP stops charging the auxiliary capacitor CX. Furthermore, when the sawtooth wave RMP drops below the first threshold voltage VT1, the auxiliary switch SWX is turned on, thereby connecting the auxiliary capacitor CX in parallel with the resonant capacitor CR.

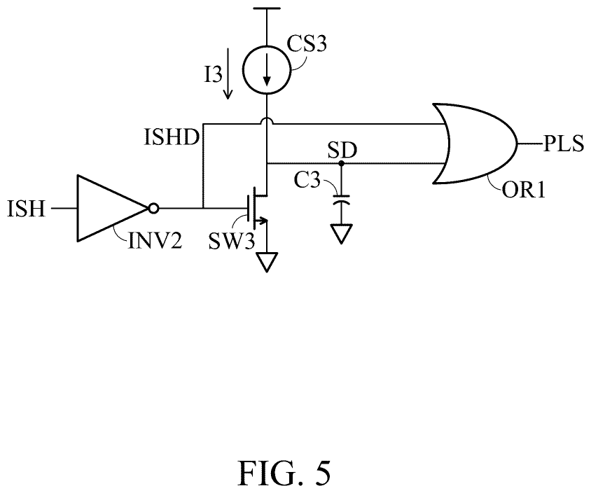

FIG. 5 is a circuit diagram of a pulse generation circuit in accordance with an embodiment of the present invention. According to an embodiment of the present invention, the pulse generation circuit 500 corresponds to the first pulse generation circuit PL1 of FIG. 4. As shown in FIG. 5, the pulse generation circuit 500 includes a second inverter INV2, a third switch SW3, a third current source CS3, a third capacitor C3, and a first OR gate OR1. When the high-side driving signal SH is disabled, the second inverter INV2 inverts the inverted high-side driving signal ISH being enabled to generate a delayed inverted high-side driving signal ISHD being disabled to turn off the third switch SW3.

When the third switch SW3 is turned off, the third current I3 generated by the third current source CS3 charges the third capacitor C3, causing the voltage of the delayed signal SD to rise. Furthermore, when the third switch SW3 is just turned off, the delay signal SD is in the disabled state. In addition to the delayed inverted high-side driving signal ISHD being disabled, the first OR gate OR1 outputs a pulse signal PLS being disabled. When the third capacitor C3 is charged until the delay signal SD is enabled, the first OR gate OR1 enables the pulse signal PLS. In other words, the width of the negative pulse of the pulse signal PLS is determined by the third current I3 and the third capacitor C3.

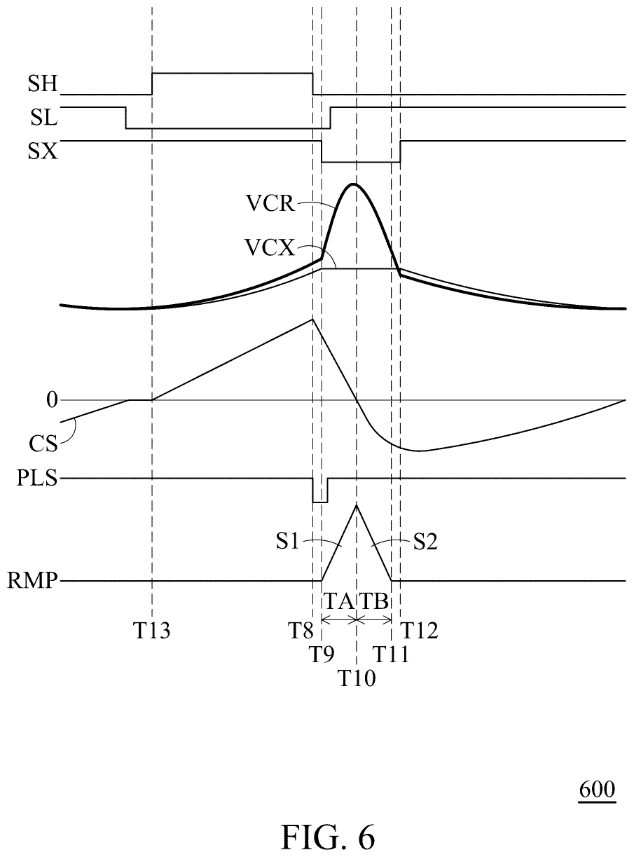

FIG. 6 is a waveform diagram of a power conversion circuit in accordance with an embodiment of the present invention. The following description of waveform diagram 600 will be combined with the power conversion circuit 300 of FIG. 3 and the delay circuit 400 of FIG. 4 for detailed explanation.

As shown in FIG. 6, the high-side driving signal SH is disabled at the eighth time point T8, and the pulse signal PLS generates a negative pulse based on the rising edge of the high-side inverted driving signal ISH, causing the auxiliary signal SX to be disabled at the ninth time point T9 to turn off the auxiliary switch SWX. The first signal S1 of FIG. 4 turns on the first switch SW1 to count the first period TA. According to some embodiments of the present invention, the eighth time point T8 to the ninth time point T9 is the delay time for the high-side driving signal SH being disabled to turn on the first switch SW1 via the first inverter INV1 and the first flip-flop FF1.

When the current detection signal CS drops to zero at the tenth time point T10, the first comparator CMP1 in FIG. 4 resets the first flip-flop FF1 to disable the first signal S1, so as to begin counting the second period TB. According to some embodiments of the present invention, during the second period TB, the second current I2 discharges the second capacitor C2. When the sawtooth wave RMP in FIG. 4 drops below the first threshold voltage VT1 at the eleventh time point T11, the auxiliary signal SX is enabled at the twelfth time point T12, so that the auxiliary capacitor CX is connected in parallel with the resonant capacitor CR.

According to some embodiments of the present invention, the eleventh time point T11 to the twelfth time point T12 is the delay time from the sawtooth wave RMP dropping below the first threshold voltage VT1 to the second comparator CMP2 and the second flip-flop FF2 enabling the auxiliary signal SX. According to some embodiments of the present invention, the first period TA is substantially equal to the second period TB. In other words, the second period TB is configured to replicate the length of the first period TA. According to some embodiments of the present invention, the first threshold voltage VT1 is close to zero. According to some embodiments of the present invention, the first period TA and the second period TB may also be zero. That is, the auxiliary switch SWX is continuously turned on and does not turn off.

According to one embodiment of the present invention, the second period TB does not exceed one-quarter of the resonant period, where the resonant period is determined by the resonant capacitor CR and the leakage inductance of the primary winding PS. According to an embodiment of the present invention, the sum of the first period TA and the second period TB does not exceed half of the resonant period.

According to some embodiments of the present invention, when the auxiliary switch SWX is turned on at the twelfth time point T12, the resonant voltage VCR is substantially equal to the auxiliary voltage VCX of the auxiliary capacitor CX. In other words, when the auxiliary capacitor CX is connected in parallel with the resonant capacitor CR at the twelfth time point T12, the auxiliary parasitic diode SWXD is turned on, so that the resonant voltage VCR is substantially equal to the auxiliary voltage VCX. On the other hand, when the auxiliary switch SWX is turned on due to a large difference between the resonant voltage VCR and the auxiliary voltage VCX, a large current will be generated between the resonant capacitor CR and the auxiliary capacitor CX, thereby affecting the normal operation of the transformer TM.

According to other embodiments of the present invention, the auxiliary switch SWX can be turned off at any time when the current detection signal CS is positive. It is illustrated that the auxiliary switch SWX is turned off at the ninth time point T9 (i.e., after the current detection signal CS is positive and the high-side transistor 111 is turned off) herein, which is not intended to be limited thereto. In other words, the falling edge of the auxiliary signal SX (i.e., the auxiliary switch SW is turned off) can be at any time point between the thirteenth time point T13 and the tenth time point T10.

Since the auxiliary switch SWX can be turned on at any time between the thirteenth time point T13 and the tenth time point T10, the period for charging the auxiliary capacitor CX can be adjusted, thereby changing the equivalent capacitance value of the auxiliary capacitor CX. When the auxiliary capacitor CX is connected in parallel with the resonant capacitor CR, a wider range of resonant periods of the power conversion circuit 300 can be obtained, allowing the power conversion circuit 300 to not only generate a wider range of output voltages but also maintain higher conversion efficiency at low output power.

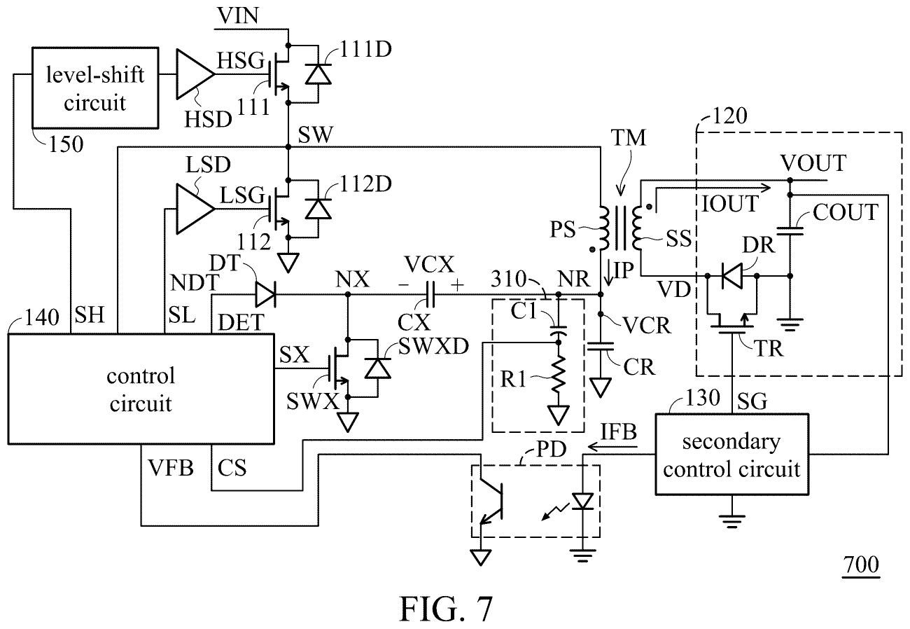

FIG. 7 is a circuit diagram of a power conversion circuit in accordance with yet another embodiment of the present invention. Compared the power conversion circuit 700 to the power conversion circuit 300 in FIG. 3, the power conversion circuit 700 further includes a detection diode DT. The detection diode DT is coupled between a detection node NDT and an auxiliary node NX. The control circuit 140 determines whether the auxiliary parasitic diode SWXD is turned on based on a detection signal DET at the detection node NDT, thereby turning on the auxiliary switch SWX to connect the auxiliary capacitor CX in parallel with the resonant capacitor CR.

According to some embodiments of the present invention, when the auxiliary parasitic diode SWXD is turned on, the auxiliary voltage VCX is essentially equal to the resonant voltage VCR, so that turning on the auxiliary switch SWX at this time does not generate a large current to affect the normal operation of the transformer TM. In addition, turning on the auxiliary switch SWX when the auxiliary parasitic diode SWXD is turned on ensures that the auxiliary switch SWX achieves zero-voltage switching.

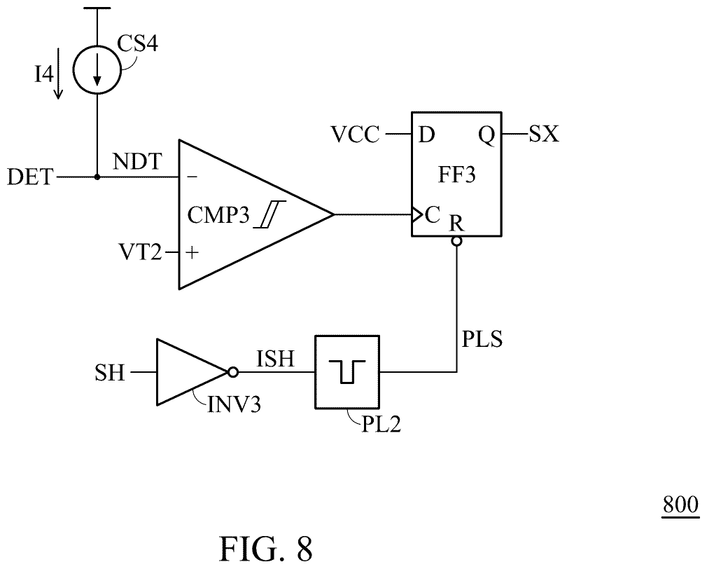

FIG. 8 is a circuit diagram of a detection circuit in accordance with an embodiment of the present invention. According to some embodiments of the present invention, the control circuit 140 in FIG. 7 includes a detection circuit 800. As shown in FIG. 8, the detection circuit 800 includes a fourth current source CS4, a third comparator CMP3, a third flip-flop FF3, a third inverter INV3, and a second pulse generation circuit PL2.

The fourth current I4 generated by the fourth current source CS4 is configured to charge the detection diode DT of FIG. 7, thereby generating a detection signal DET at the detection node DT. When the detection signal DET drops below the second threshold voltage VT2, the rising edge of the output of the third comparator CMP3 triggers the third flip-flop FF3 to output the supply voltage VCC as the auxiliary signal SX, thereby enabling the auxiliary signal SX.

When the high-side driving signal SH is disabled, the third inverter INV3 enables the inverted high-side driving signal ISH, causing the second pulse generation circuit PL2 to generate a negative pulse on the pulse signal PLS, thereby resetting the third flip-flop FF3 to disable the auxiliary signal SX. According to some embodiments of the present invention, the second pulse generation circuit PL2 corresponds to the pulse generation circuit 500 of FIG. 5.

According to some embodiments of the present invention, when the auxiliary parasitic diode SWXD of FIG. 7 is turned on, the voltage of the auxiliary node NX drops to a negative voltage, causing the detection signal DET to be close to zero. When the detection signal DET drops below the second threshold voltage VT2, it indicates that the auxiliary parasitic diode SWXD is turned on and the auxiliary voltage VCX is substantially equal to the resonant voltage VCR. Therefore, the third flip-flop FF3 enables the auxiliary signal SX based on the rising edge generated by the third comparator CMP3, thereby turning on the auxiliary switch SWX to connect the auxiliary capacitor CX in parallel with the resonant capacitor CR.

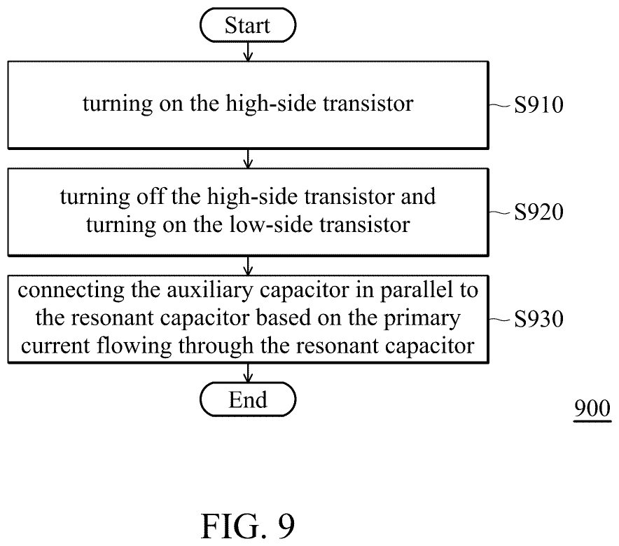

FIG. 9 is a flow chart of a control method for a power conversion circuit in accordance with an embodiment of the present invention. The following description of flow chart 900 will be combined with the power conversion circuit 300 of FIG. 3 and the power conversion circuit 700 of FIG. 7 for detailed explanation.

First, the high-side transistor 111 is turned on (Step S910) to magnetize the transformer TM and charge the resonant capacitor CR. The high-side transistor 111 is turned off and the low-side transistor 112 is turned on (Step S920) to generate an output voltage VOUT at the secondary winding SS. Based on the primary current IP flowing through the resonant capacitor CR, the auxiliary capacitor CX is connected in parallel to the resonant capacitor CR (Step S930).

According to one embodiment of the present invention, when the primary current IP flows from the resonant node NR to the ground (i.e., the current detection signal CS is positive), the auxiliary capacitor CX is electrically separated from the resonant capacitor CR. According to another embodiment of the present invention, when the primary current IP flows from the ground to the resonant node NR (i.e., the current detection signal CS is negative), the auxiliary capacitor CX is connected in parallel with the resonant capacitor CR. According to yet another embodiment of the present invention, when the primary current IP flows from the resonant node NR to the ground (i.e., the current detection signal CS is positive) and the high-side transistor 111 is turned off (as shown in FIG. 6), the auxiliary capacitor CX is electrically separated from the resonant capacitor CR.

The present invention proposes a resonant power conversion circuit and a control method thereof. By connecting an additional auxiliary capacitor in parallel with the resonant capacitor, the maximum primary current of the primary coil and the maximum output current of the secondary coil are reduced, which helps to reduce the conduction loss of the low-side transistor and the rectification transistor, thereby improving the conversion efficiency at the conditions of low output voltage and light load. In addition, by adjusting the charging period of the auxiliary capacitor, the equivalent capacitance value of the auxiliary capacitor may be adjusted. When the auxiliary capacitor is connected in parallel with the resonant capacitor, the resonant period of the resonant power conversion circuit may be adjusted to a wider extent, allowing the resonant power conversion circuit to generate a wider range of output voltages and improve the conversion efficiency at low output power.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil and a secondary coil, wherein the primary coil is coupled between a switch node and a resonant node;
a resonant capacitor, coupled between the resonant node and a ground;
a high-side transistor, providing an input voltage to the switch node based on a high-side driving signal;
a low-side transistor, coupling the switch node to the ground based on a low-side driving signal;
an auxiliary capacitor, coupled between the resonant node and an auxiliary node;
an auxiliary switch, coupled between the auxiliary node and the ground; and
a control circuit, generating the high-side driving signal and the low-side driving signal;
wherein the control circuit turns on the auxiliary switch based on a primary current flowing through the resonant capacitor, so that the auxiliary capacitor is connected in parallel with the resonant capacitor.

2. The power conversion circuit as claimed in claim 1, further comprising:
a current detection circuit, configured to detect the primary current to generate a current detection signal;
wherein when the primary current flows from the resonant node to the ground, the current detection signal is positive;
wherein when the primary current flows from the ground to the resonant node, the current detection signal is negative.

3. The power conversion circuit as claimed in claim 2, wherein the current detection circuit comprises:
a first capacitor, coupled to the resonant node; and
a first resistor, coupled between the first capacitor and the ground;
wherein a voltage across the first resistor generates the current detection signal.

4. The power conversion circuit as claimed in claim 2, wherein when the current detection signal is positive, the control circuit turns off the auxiliary switch.

5. The power conversion circuit as claimed in claim 2, wherein when the current detection signal is positive and the high-side transistor is turned off, the control circuit turns off the auxiliary switch.

6. The power conversion circuit as claimed in claim 2, wherein when the current detection signal transitions to negative and a delay time has elapsed, the control circuit turns on the auxiliary switch.

7. The power conversion circuit as claimed in claim 6, wherein the control circuit further comprises:
a delay circuit, configured to generate a first signal and a second signal;
wherein the delay circuit enables the first signal during a period from the high-side transistor being turned off to the current detection signal dropping to zero;
wherein when the current detection signal drops to zero, the delay circuit enables the second signal;
wherein an enable period of the second signal is substantially equal to an enable period of the first signal;
wherein the delay time is equal to the enable period of the second signal.

8. The power conversion circuit as claimed in claim 7, wherein a resonant frequency of the power conversion circuit is determined by the resonant capacitor and a leakage inductance of the primary coil;
wherein the delay time does not exceed one-quarter of the resonant frequency.

9. The power conversion circuit as claimed in claim 6, wherein when the control circuit turns on the auxiliary switch, a voltage across the auxiliary capacitor is close to a voltage across the resonant capacitor.

10. A power conversion circuit, comprising:
a transformer, comprising a primary coil and a secondary coil, wherein the primary coil is coupled between a switch node and a resonant node;
a resonant capacitor, coupled between the resonant node and a ground, wherein a primary current flows through the resonant capacitor;
a high-side transistor, providing an input voltage to the switch node based on a high-side driving signal;
a low-side transistor, coupling the switch node to the ground based on a low-side driving signal;
an auxiliary capacitor, coupled between the resonant node and an auxiliary node;
an auxiliary switch, coupled between the auxiliary node and the ground; and
a control circuit, generating the high-side driving signal and the low-side driving signal;
wherein when a parasitic diode of the auxiliary switch is turned on, the auxiliary switch is turned on so that the auxiliary capacitor is connected in parallel with the resonant capacitor.

11. The power conversion circuit as claimed in claim 10, wherein when the primary current flows from the resonant node to the ground, the control circuit turns off the auxiliary switch.

12. The power conversion circuit as claimed in claim 10, wherein when the primary current flows from the resonant node to the ground and the high-side transistor is turned off, the control circuit turns off the auxiliary switch.

13. The power conversion circuit as claimed in claim 10, further comprising:
a current detection circuit, configured to detect the primary current to generate a current detection signal;
wherein when the primary current flows from the resonant node to the ground, the current detection signal is positive;
wherein when the primary current flows from the ground to the resonant node, the current detection signal is negative;
wherein when the current detection signal is positive, the control circuit turns off the auxiliary switch;
wherein when the current detection signal is negative, the control circuit turns on the auxiliary switch.

14. The power conversion circuit as claimed in claim 10, wherein when the auxiliary switch is turned on, the auxiliary switch achieves zero-voltage switching.

15. The power conversion circuit as claimed in claim 10, further comprising:
a detection diode, comprising an anode and a cathode;
wherein the anode is coupled to a detection node, the cathode is coupled to the auxiliary node;
wherein the control circuit further comprises a current source, and the current source provides a fixed current to flow through the detection diode;
wherein when a voltage of the detection node is less than a threshold, the control circuit determines that a parasitic diode of the auxiliary switch is turned on and turns on the auxiliary switch.

16. A control method for controlling a power conversion circuit, wherein the power conversion circuit comprises a resonant capacitor coupled between a resonant node and a ground, a transformer comprising a primary coil and a secondary coil, a high-side transistor providing an input voltage to a switch node, and a low-side transistor coupling the switch node to the ground, wherein the primary coil is coupled between the switch node and the resonant node, wherein the control method comprises:
turning on the high-side transistor to magnetize the transformer and to charge the resonant capacitor;
turning off the high-side transistor and turning on the low-side transistor so that the secondary coil generates an output voltage; and
connecting an auxiliary capacitor in parallel with the resonant capacitor based on a primary current flowing through the resonant capacitor.

17. The control method as claimed in claim 16, wherein the step of connecting the auxiliary capacitor in parallel with the resonant capacitor based on the primary current flowing through the resonant capacitor further comprises:
when the primary current flows from the resonant node to the ground and the high-side transistor is turned off, electrically separating the auxiliary capacitor from the resonant capacitor.

18. The control method as claimed in claim 16, wherein the step of connecting the auxiliary capacitor in parallel with the resonant capacitor based on the primary current flowing through the resonant capacitor further comprises:
electrically separating the auxiliary capacitor from the resonant capacitor when the primary current flows from the resonant node to the ground; and
connecting the auxiliary capacitor in parallel with the resonant capacitor when the primary current flows from the ground to the resonant node.

19. The control method as claimed in claim 18, wherein the step of connecting the auxiliary capacitor in parallel with the resonant capacitor when the primary current flows from the ground to the resonant node further comprises:
connecting the auxiliary capacitor in parallel with the resonant capacitor when a voltage across the auxiliary capacitor is close to a voltage across the resonant capacitor.

20. The control method as claimed in claim 17, wherein the auxiliary capacitor is coupled to an auxiliary switch;
wherein the auxiliary capacitor is connected in parallel with the resonant capacitor when the auxiliary switch is turned on;
wherein the auxiliary switch achieves zero-voltage switching when the auxiliary switch is turned on.
